(19) United States
(12) Patent Application Publication
(10) Pub. No.: US 2019/0243438 A1
(43) Pub. Date: Aug. 8, 2019

(54) METHOD AND SYSTEM FOR DEPLOYING DYNAMIC VIRTUAL OBJECT FOR REDUCING POWER IN MOBILE EDGE COMPUTING ENVIRONMENT

(71) Applicant: KOREA ADVANCED INSTITUTE OF SCIENCE AND TECHNOLOGY, Daejeon (KR)

(72) Inventors: HongShik PARK, Daejeon (KR); Jae Won AHN, Daejeon (KR); Hyeontaek OH, Daejeon (KR)

(73) Assignee: KOREA ADVANCED INSTITUTE OF SCIENCE AND TECHNOLOGY, Daejeon (KR)

(21) Appl. No.: 15/950,424

(22) Filed: Apr. 11, 2018

(30) Foreign Application Priority Data
Feb. 8, 2018 (KR) 10-2018-0015443

(51) Int. Cl. G06F 1/32; H04L 29/08; H04L 12/26; G06F 9/455

(52) U.S. Cl. CPC G06F 1/329; H04L 67/1008; H04L 43/08; G06F 2009/45595; G06F 9/45558; G06F 2009/4557; H04L 67/1023

(57) ABSTRACT

Disclosed herein are a method and system for dynamically deploying a virtual object for reducing power in a mobile edge computing environment. The method of dynamically deploying a virtual object may include measuring the popularity of each mobile edge computing (MEC) server by counting the number of requests input to an MEC environment and the number of input requests of each of virtual objects disposed in an MEC server and performing load balancing so that the requests are equally distributed to the MEC servers through an algorithm to minimize a dispersion of a popularity of each MEC server.

### CROSS REFERENCE TO RELATED APPLICATION

The present application claims the benefit of Korean Patent Application No. 10-2018-0015443 filed in the Korean Intellectual Property Office on Feb. 8, 2018, the entire contents of which are incorporated herein by reference.

### BACKGROUND OF THE INVENTION

### Technical Field

The present invention relates to a method and system for dynamically deploying a virtual object for reducing power in a mobile edge computing environment.

### Description of the Related Art

Mobile edge computing (MEC) is a technology for reducing the congestion of a mobile core network and creating a new local service by deploying various services and cashing content close to a user terminal through the application of a distributed cloud computing technology to a wireless base station.

A standardization task for the MEC is in progress at the initiative of the European Telecommunications Standard Institute (ETSI). The MEC emerges as a main component technology of the 5G network because it can significantly reduce service transfer latency.

Services capable of using the MEC include an intelligent video analysis service and a high bandwidth low latency content transfer service, and may additionally support various 5G services, such as a voice recognition-based service.

In accordance with the MEC market forecast report, it is expected that 563,000 MECs will be divided and installed at 2,000 places in the USA only in 2026. It is expected that power consumption will suddenly increase due to such an MEC equipment extension.

In accordance with survey data, an average of power consumed by one server of a data center in 2016 is about 300 W. The best of a power utilization effectiveness (PUE) value indicative of power efficiency of the data center is 1.8 (better when the PUE is lower).

Power of 2.66T Wh is consumed a year in the USA due to the extension of (563000units*300W*365 day*24 hour*1.8PUE) MEC equipment by simple calculation. This means that a cost of 220 billion Korean won may be generated due to power consumption.

It is also expected that the PUE will further increase because it is difficult to install the MEC equipment at an energy efficient place like a data center because the MEC equipment must be located near a user.

Furthermore, in accordance with a scientific journal, the data center can reduce total consumption energy of about 20% compared to the existing data center because it is free cooled in cold areas.

However, current technology development is focused on a power consumption reduction technology for a power reduction of a mobile device not on a reduction of power consumption for an MEC server.

Research for improving battery lifespan, that is, one of great quality of experience (QoE) items of a mobile user, is in progress in such a manner that the calculation of a mobile device is offloaded to an MEC and the MEC performs the calculation of the mobile device based on the idea that the MEC is located near the mobile device of a user.

For example, a mobile phone requires a machine learning technology, such as face recognition or voice recognition. If the mobile phone performs such calculation, the QoE is reduced (i.e., battery power is rapidly reduced) because limited battery resources must be consumed.

If only data to be processed is delivered to a nearby MEC and the MEC performs calculation and deliver only result values to a mobile phone, a mobile user can experiences better battery lifespan.

Such research has a sufficient meaning, but there is a need for a technology capable of solving power consumed by an MEC server because the power consumed by the MEC server is nothing to sneeze.

### SUMMARY OF THE INVENTION

An object of the present invention is to provide a method and system for dynamically deploying a virtual object for reducing power consumption generated by an MEC in preparation for a sudden increase of power consumption attributable to an MEC equipment extension. Furthermore, an object of the present invention is to solve a problem in that the PUE is expected to further increase because it is difficult to install MEC equipment at an energy efficient place like a data center owing to the limit that the MEC equipment must be located near a user.

In one aspect, a method of dynamically deploying a virtual object for a power reduction in an MEC environment includes measuring the popularity of each mobile edge computing (MEC) server by counting the number of requests input to an MEC environment and the number of input requests of each of virtual objects disposed in an MEC server and performing load balancing so that the requests are equally distributed to the MEC servers through an algorithm to minimize the dispersion of the popularity of each MEC server.

The measuring of the popularity of each MEC includes measuring the popularity of each virtual object during a reference time by counting the number of requests input to the MEC environment and the number of requests input for each virtual object installed in the MEC server and measuring the popularity of each MEC server based on the sum of the popularities of the virtual objects measured during the reference time.

The performing of the load balancing includes using a heuristic virtual object deployment algorithm in which the popularity of a virtual object is taken into consideration and the redeployment of the virtual object is terminated when dispersion is less than a reference value when selecting the virtual object to be moved in order to minimize power consumption of the MEC servers.

The performing of the load balancing includes selecting a target redeployment virtual object and deploying the target redeployment virtual object.

The selecting of the target redeployment virtual object includes generating and initializing a set of target redeployment VOs, indexing and initializing the MEC servers in the MEC environment, and sequentially searching all of the MEC servers for a target redeployment VO.

The deploying of the target redeployment virtual object includes indexing a set of target redeployment virtual objects in descending power for popularity, indexing MEC servers having popularities smaller than an average of the set of target redeployment virtual objects in ascending power for popularity, and distributing each of the indexed target redeployment virtual objects to each of the indexed MEC servers.

In another aspect, a system for dynamically deploying a virtual object includes a popularity measurement unit configured to measure the popularity of each mobile edge computing (MEC) server by counting the number of requests input to an MEC environment and the number of input requests of each of virtual objects disposed in an MEC server and a load balancing unit configured to perform load balancing so that the requests are equally distributed to the MEC servers through an algorithm to minimize the dispersion of the popularity of each MEC server.

The popularity measurement unit is configured to measure the popularity of each virtual object during a reference time by counting the number of requests input to the MEC environment and the number of requests input for each virtual object installed in the MEC server and to measure the popularity of each MEC server based on the sum of the popularities of the virtual objects measured during the reference time.

The load balancing unit is configured to use a heuristic virtual object deployment algorithm in which the popularity of a virtual object is taken into consideration and the redeployment of the virtual object is terminated when dispersion is less than a reference value, when selecting the virtual object to be moved in order to minimize power consumption of the MEC servers.

The load balancing unit includes a virtual object selection unit configured to select a target redeployment virtual object and a virtual object deployment unit configured to dispose the target redeployment virtual object.

The virtual object selection unit is configured to generate and initialize a set of target redeployment VOs, index and initialize the MEC servers in the MEC environment, and sequentially search all of the MEC servers for a target redeployment VO.

The virtual object deployment unit is configured to index a set of target redeployment virtual objects in descending power for popularity, index MEC servers having popularities smaller than an average of the set of target redeployment virtual objects in ascending power for popularity, and distribute each of the indexed target redeployment virtual objects to each of the indexed MEC servers.

### BRIEF DESCRIPTION OF THE DRAWINGS

FIG. 1 is a diagram showing an MEC environment according to an embodiment of the present invention.

FIG. 2 is a diagram for illustrating ESTI standardization according to an embodiment of the present invention.

FIG. 3 is a flowchart for illustrating a method of dynamically deploying a virtual object for a power reduction in the MEC environment according to an embodiment of the present invention.

FIG. 4 is a flowchart for illustrating a process of selecting a target redeployment virtual object according to an embodiment of the present invention.

FIG. 5 is a flowchart for illustrating a process of deploying a target redeployment virtual object according to an embodiment of the present invention.

FIG. 6 is a diagram for illustrating a system for dynamically deploying a virtual object for a power reduction in the MEC environment according to an embodiment of the present invention.

### DETAILED DESCRIPTION

Embodiments of the present invention are described in detail with reference to the accompanying drawings.

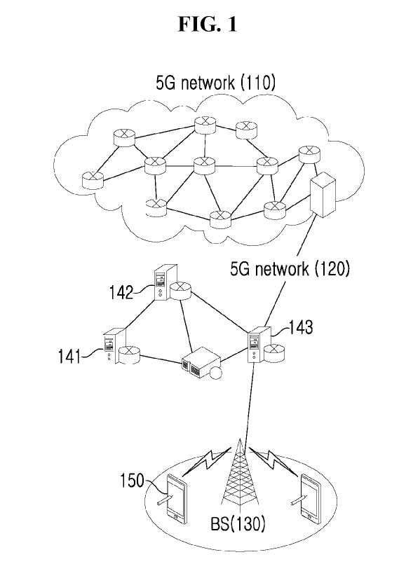

FIG. 1 is a diagram showing an MEC environment according to an embodiment of the present invention.

Embodiments of the present invention relate to a method and system for dynamically deploying a virtual object for reducing power consumption generated in an MEC, and they propose a technology for dynamically deploying a virtual object so that all the CPU loads of MEC servers in an assumed MEC environment are constantly maintained. In an embodiment of the present invention, the configuration of an MEC based on contents standardized in the ETSI is assumed because international standardization for an MEC structure has not yet been finished.

A virtual object performs its unique function (e.g., the type of virtual object includes a virtual switch, a virtual firewall, and a mobile edge application), so there is a probability (i.e., popularity) that a request may be received for each virtual object.

Each MEC server may obtain the popularity of each MEC by adding the popularities of virtual objects in the server together, and dynamically deploys the virtual objects so that the popularity of each MEC is close to an MEC popularity average as much as possible.

A recent CPU reduces energy using a dynamic voltage frequency scaling (DVFS) method. In this case, power consumption of a server according to a CPU load depends on a convex function. In other words, assuming that all of MEC servers in one MEC environment are turned on, consumption power of all the MEC servers can be reduced by equally distributing tasks to all the MEC servers rather than by allowing some of the MEC servers to process all of requests input to MECs.

An environment in which MEC servers are disposed is shown in FIG. 1. As described above, it is expected that the environment in which the MEC servers have been disposed will include an MEC server group 141, 142 and 143 between a 5G network 120 on a mobile network and a base station (BS) (or eNode B) 130 on the basis of the 5G network 110.

A plurality of MEC servers will be physically disposed for each mobile edge 150. An embodiment of the present invention may be applied in the MEC server group on a single mobile edge or may be applied in all of MEC servers in the MEC environment. In order to help understanding of the present invention, an MEC server group and an MEC environment are collectively called an MEC environment.

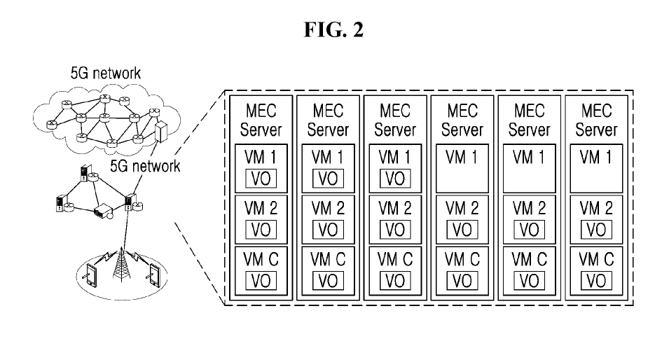

FIG. 2 is a diagram for illustrating ESTI standardization according to an embodiment of the present invention.

In assumption according to an ETSI standardization progress situation, contents related to an MEC structure has not yet been standardized in the ETSI. Accordingly, an environment to which the present invention is applied based on the contents of the ETSI standardization is assumed.

An MEC requires a flexible and fast networking technology for a connection between the servers of the MECs. To this end, an NFV technology may be used for the MEC.

The NFV configures legacy networking equipment (e.g., a firewall, a load balancer, a switch and a router) using a virtual network function called a VNF. The legacy networking equipment is driven on a virtual machine.

The MEC includes mobile edge applications (ME apps) (e.g., video analysis, voice data processing using a learning machine, and content delivery) that perform the function of the MEC. The ME apps are driven on the VM like the VNF. As shown in FIG. 2, in an embodiment of the present invention, the VM and the ME apps are called one virtual object (hereinafter referred to as a “VO”), and one VM has one VO.

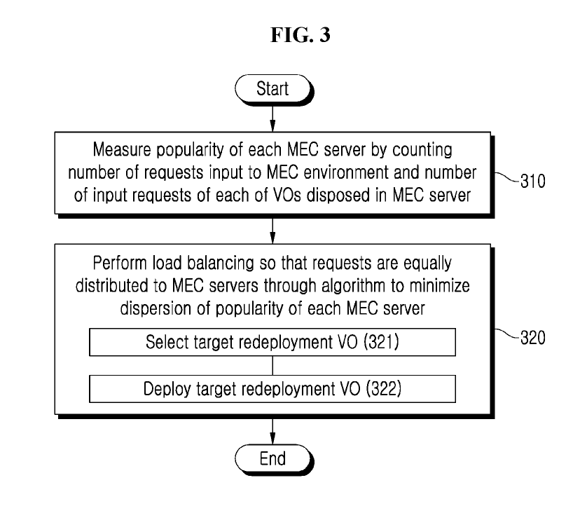

FIG. 3 is a flowchart for illustrating a method of dynamically deploying a VO for a power reduction in the MEC environment according to an embodiment of the present invention.

The proposed method of dynamically deploying a VO for a power reduction in the MEC environment includes measuring the popularity of each MEC server by counting the number of requests input to an MEC environment and the number of input requests of each of VOs disposed in an MEC server at step 310, and performing load balancing so that the requests are equally distributed to the MEC servers through an algorithm to minimize the dispersion of the popularity of each MEC server at step 320.

At step 310, the popularity of each MEC server is measured by counting the number of requests input to the MEC environment and the number of input requests of each of VOs disposed in the MEC server. Specifically, the popularity of each VO during a reference time is measured by counting the number of requests input to the MEC environment and the number of requests input for each VO installed in the MEC server. The popularity of each MEC server is measured based on the sum of the popularities of the VOs measured during the reference time.

More specifically, the popularity of a VO during a reference time is measured by counting a request (or query) input to the MEC environment during every time range and counting the number of requests input to each VO. The popularity pᵥₗ of a VOl may be calculated by (the number of requests input to a VOj)/(the total number of requests inputs to the MEC environment).

The popularity of each MEC server is measured based on the sum of the popularities of VOs disposed in the MEC server. The popularity of the MEC server k is named “pₘₖ”. A probability that a request will be input to the MEC server may be calculated based on the sum of simple popularities because the VOs disposed in the MEC server separately operate.

At step 320, load balancing is performed so that requests are equally distributed to the MEC servers through the algorithm to minimize the dispersion of the popularity of each MEC server.

When a VO to be moved is selected so as to minimize power consumption of MEC servers, a heuristic VO deployment algorithm in which the popularity of a VO is taken into consideration and the redeployment of a VO is terminated when dispersion is less than a reference value is used.

A load balancing operation is performed so that requests are equally distributed to MEC servers using the algorithm to minimize the dispersion of the popularity of each MEC server. In order to equally distribute the loads of MEC servers, the VOs of each MEC server in the MEC environment need to be properly disposed. This can be solved through an NP-complete problem (multi-knapsack problem).

For example, assuming that five MEC servers are present, if the amounts of loads in the servers is L={0.1, 0.1, 0.2, 0.25, 0.25}, it needs to be L={0.2, 0.2, 0.2, 0.2, 0.2}. If the popularities of VOs disposed in the five MEC servers are {{0.1}, {0.05, 0.05}, {0.1, 0.1}, {0.05, 0.2}, {0.05, 0.1, 0.2}}, each of all the MEC servers has the popularity of 0.2 by deploying a VO having a popularity of 0.05 in the fourth server in the first server and deploying VOs having popularities of 0.05 and 0.1 in the fifth server in the first server and the second server.

However, if the popularities of the VOs disposed in the MEC servers are {{0.03, 0.07}, {0.1}, {0.2}, {0.25}, {0.1, 0.1, 0.05}}, in order to reduce dispersion, a VO having a popularity of 0.1 in the fifth server is simply disposed in the first server, and optimization is terminated.

An embodiment of the present invention proposes the heuristic VO deployment algorithm in which the popularity of a VO is flexibly taken into consideration when selecting a VO to be moved and the redeployment of a VO is terminated when dispersion is less than a reference value is used, and also proposes an algorithm to minimize power consumption of MEC servers.

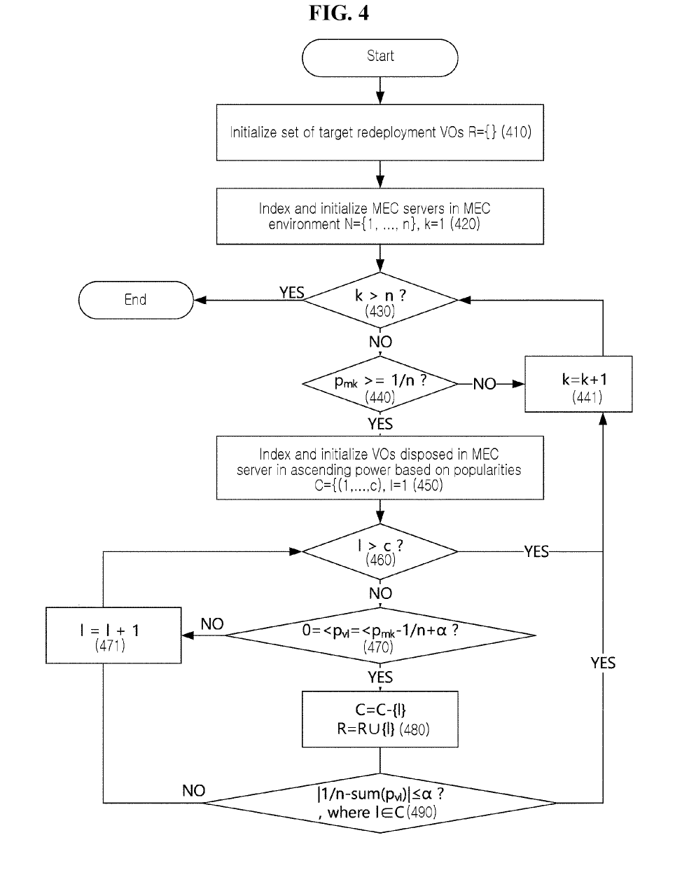

FIG. 4 is a flowchart for illustrating a process of selecting a target redeployment VO according to an embodiment of the present invention.

Step 320 includes selecting a target redeployment VO at step 321 and deploying the target redeployment VO at step 322.

Step 321 includes generating and initializing a set of target redeployment VOs, indexing and initializing the MEC servers in the MEC environment, and sequentially searching all of the MEC servers for a target redeployment VO.

More specifically, a set R of target redeployment VOs is generated and initialized: R={ } (410). The MEC servers in the MEC environment are indexed and initialized: N={1, n}, k=1 (420). Assuming that the number of MEC servers is n, the MEC servers are indexed No. 1 to No. n. Thereafter, the MEC servers are alternately searched for a target redeployment VO one by one.

Whether an MEC server k is greater than n is determined (430). If, as a result of the determination, the MEC server k is greater than n, the process is terminated. If not, whether the popularity pₘₖ of the MEC server k is an average MEC server popularity 1/n or more is determined (440). If, as a result of the determination, the popularity pₘₖ is smaller than 1/n, k=k+1 is taken (441) and the process proceeds to step 430.

If the popularity pₘₖ of the MEC server k is 1/n or more, a redeployment target VO is searched for in detail. VOs disposed in the MEC server k are indexed from 1 to c in ascending power based on their popularities pᵥₗ: C={(1, . . . , c)|pᵥ₁≤pᵥ₂≤ . . . ≤p_{vc}} (450).

Thereafter, 1 is compared with c (460). If, as a result of the comparison, 1 is greater than c, whether the popularity pᵥₗ of a VOl complies with a heuristically set popularity range is determined (470). If, as a result of the determination, the popularity pᵥₗ does not comply with the heuristically set popularity range, l=l+1 is taken (471), and the process proceeds to step 460.

In this case, the popularity range refers to a range equal to or smaller than a value obtained by adding the value of an additional marginal popularity range a to a difference between the popularity pₘₖ of the MEC server k and the average MEC server popularity 1/n. A VO having a popularity within the popularity range is deleted from C and is included in R: C=C−{l} & R=R∪{l} (480). If the sum of the popularities of the remaining VOs fall within the 1/n±α range, the search for a target redeployment VO is terminated. If not, l←l+1 is taken, and re-search is performed (490).

For example, if five MEC servers are present and requests {{1,1}, {1,1,1}, {1,3}, {1,1,3}, {1,1,2,2}} are input to the VOs of the MEC servers, the fourth and fifth servers that receive five or six requests need to redeploy a VO that receives one or two requests because an average of four requests is input to each server. The fourth server may set a first VO as a redeployment target and stop search because the remaining number of requests is 4. The fifth server may set first and second VOs as redeployment targets and stop search for VO redeployment because the remaining number of requests is 4.

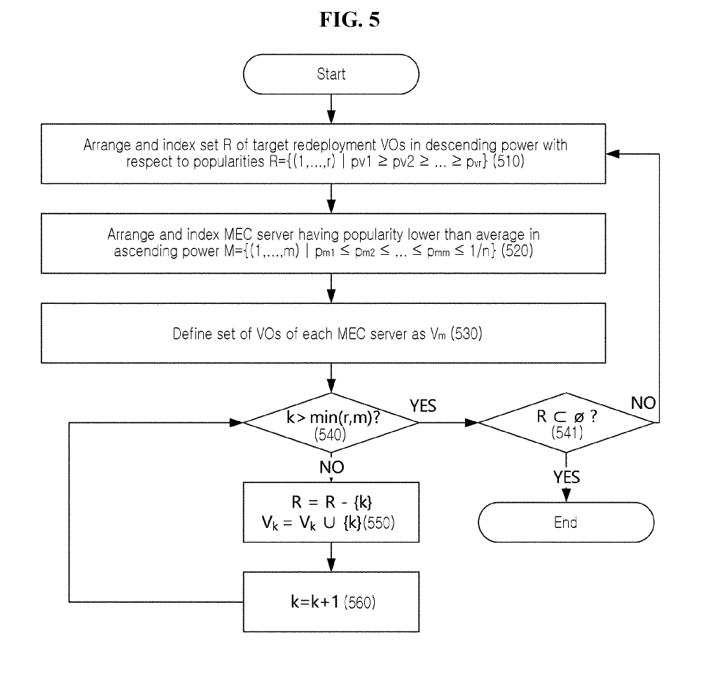

FIG. 5 is a flowchart for illustrating a process of deploying a target redeployment VO according to an embodiment of the present invention.

Step 322 of deploying the target redeployment VO includes indexing a set of target redeployment VOs in descending power for popularity, indexing an MEC server having popularity lower than an average of the set of target redeployment VOs in ascending power for popularity, and distributing each indexed target redeployment VO to each indexed MEC server.

In the proposed method of deploying a target redeployment VO, first, a set R of target redeployment VOs is indexed in descending power with respect to their popularities: R={(1, . . . , r)|pᵥ₁≥pᵥ₂≥ . . . ≥pᵥᵣ} (510). An MEC server having popularity lower than an average is indexed in ascending power: M={(1, . . . , m)|pₘ₁≤pₘ₂≤ . . . ≤pₘₘ ≤1/n} (520). Thereafter, a set of VOs of each MEC server is named Vₘ (530).

Each VO is distributed to each MEC server while raising the index k by 1 (k≤min(m,r)) (540).

Since the MEC servers have been arranged in ascending power and the set R has been arranged in descending power, a VO having the highest popularity has been distributed to an MEC server having the lowest popularity: R=R−{k}, Vₖ=Vₖ∪{k} (550). Thereafter, k=k+1 is taken (560), and the process proceeds to step 540.

If m≤rat step (541), the process proceeds to step 510 in which R and M are arranged again, and each VO is distributed to each MEC server. If there is no VO to be distributed, VO redeployment is terminated.

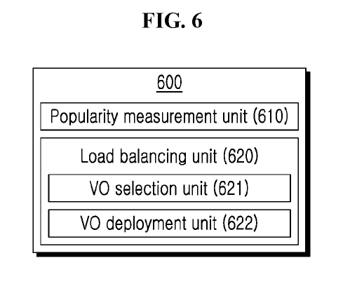

FIG. 6 is a diagram for illustrating a system for dynamically deploying a VO for a power reduction in the MEC environment according to an embodiment of the present invention.

The proposed system for dynamically deploying a VO for a power reduction in the proposed MEC environment includes a popularity measurement unit 610 and a load balancing unit 620.

The popularity measurement unit 610 measures the popularity of each MEC server by counting the number of requests input to an MEC environment and the number of input requests of each of VOs disposed in an MEC server.

The popularity measurement unit 610 measures the popularity of a VO during a reference time by counting the number of requests input to the MEC environment and the number of requests input for each VO installed in the MEC server, and measures the popularity of each MEC server based on the sum of the popularities of the VOs measured during the reference time.

The load balancing unit 620 performs load balancing so that the requests are equally distributed to the MEC servers through an algorithm to minimize the dispersion of the popularity of each MEC server.

The load balancing unit 620 uses a heuristic VO deployment algorithm in which the popularity of a VO is taken into consideration and the redeployment of a VO is terminated when dispersion is less than a reference value is used when selecting a VO to be moved so as to minimize power consumption of MEC servers.

The load balancing unit 620 includes a VO selection unit 621 and a VO deployment unit 622.

The VO selection unit 621 selects a target redeployment VO. The VO selection unit 621 indexes and initializes a set of target redeployment VOs, indexes and initializes MEC servers in the MEC environment, and sequentially searches all of the MEC servers for a target redeployment VO.

The VO deployment unit 622 deploys a target redeployment VO. The VO deployment unit 622 indexes a set of target redeployment VOs in descending power for popularity, indexes an MEC server having a popularity lower than an average of the set of target redeployment VOs in ascending power for popularity, and distributes each indexed target redeployment VO to each indexed MEC server.

The embodiments of the present invention can provide the method and system for dynamically deploying a VO for reducing power consumption generated in an MEC in preparation for a sudden increase of power consumption attributable to an MEC equipment extension. Furthermore, a problem in that the PUE is expected to further increase because it is difficult to install MEC equipment at an energy efficient place like a data center owing to the limit that the MEC equipment must be located near a user can be solved. It is expected that an environment problem according to the growth of the MEC can be solved.

The apparatus described above may be implemented in the form of a combination of hardware elements, software elements, and/or hardware elements and software elements. For example, the apparatus and elements described in the embodiments may be implemented using one or more general-purpose computers or special-purpose computers, for example, a processor, a controller, an arithmetic logic unit (ALU), a digital signal processor, a microcomputer, a field programmable array (FPA), a programmable logic unit (PLU), a microprocessor or any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may be aware that the processing device may include a plurality of processing elements and/or a plurality of types of processing elements. For example, the processing device may include a plurality of processors or a single processor and a single controller. Furthermore, other processing configurations, such as a parallel processor, are also possible.

Software may include a computer program, code, an instruction or one or more combinations of them and may configure the processing device so that it operates as desired or may instruct the processing device independently or collectively. Software and/or data may be interpreted by the processing device or may be embodied in a machine, component, physical device, virtual equipment or computer storage medium or device of any type or a transmitted signal wave permanently or temporarily in order to provide an instruction or data to the processing device. Software may be distributed to computer systems connected over a network and may be stored or executed in a distributed manner. Software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure solely or in combination. The program instruction recorded on the recording medium may have been specially designed and configured for the embodiment or may be known to those skilled in computer software. The computer-readable recording medium includes a hardware device specially configured to store and execute the program instruction, for example, magnetic media such as a hard disk, a floppy disk, and a magnetic tape, optical media such as CD-ROM or a DVD, magneto-optical media such as a floptical disk, ROM, RAM, or flash memory. Examples of the program instruction may include both machine-language code, such as code written by a compiler, and high-level language code executable by a computer using an interpreter.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and the equivalents of the claims belong to the scope of the claims.

What is claimed:

1. A method of dynamically deploying a virtual object, comprising:
measuring a popularity of each mobile edge computing (MEC) server by counting a number of requests input to an MEC environment and a number of input requests of each of virtual objects disposed in an MEC server; and
performing load balancing so that the requests are equally distributed to the MEC servers through an algorithm to minimize a dispersion of a popularity of each MEC server.

2. The method of claim 1, wherein the measuring of the popularity of each MEC comprises:
measuring a popularity of each virtual object during a reference time by counting the number of requests input to the MEC environment and the number of requests input for each virtual object installed in the MEC server, and
measuring the popularity of each MEC server based on a sum of the popularities of the virtual objects measured during the reference time.

3. The method of claim 1, wherein the performing of the load balancing comprises using a heuristic virtual object deployment algorithm in which the popularity of a virtual object is taken into consideration and a redeployment of the virtual object is terminated when dispersion is less than a reference value when selecting the virtual object to be moved in order to minimize power consumption of the MEC servers.

4. The method of claim 3, wherein the performing of the load balancing comprises:
selecting a target redeployment virtual object; and
deploying the target redeployment virtual object.

5. The method of claim 4, wherein the selecting of the target redeployment virtual object comprises:
generating and initializing a set of target redeployment VOs,
indexing and initializing the MEC servers in the MEC environment, and
sequentially searching all of the MEC servers for a target redeployment VO.

6. The method of claim 4, wherein the deploying of the target redeployment virtual object comprises:
indexing a set of target redeployment virtual objects in descending power for popularity;
indexing MEC servers having popularities smaller than an average of the set of target redeployment virtual objects in ascending power for popularity; and
distributing each of the indexed target redeployment virtual objects to each of the indexed MEC servers.

7. A system for dynamically deploying a virtual object, comprising:
a popularity measurement unit configured to measure a popularity of each mobile edge computing (MEC) server by counting a number of requests input to an MEC environment and a number of input requests of each of virtual objects disposed in an MEC server; and
a load balancing unit configured to perform load balancing so that the requests are equally distributed to the MEC servers through an algorithm to minimize a dispersion of a popularity of each MEC server.

8. The system of claim 7, wherein the popularity measurement unit is configured to:
measure a popularity of each virtual object during a reference time by counting the number of requests input to the MEC environment and the number of requests input for each virtual object installed in the MEC server, and
measure the popularity of each MEC server based on a sum of the popularities of the virtual objects measured during the reference time.

9. The system of claim 7, wherein the load balancing unit is configured to use a heuristic virtual object deployment algorithm in which the popularity of a virtual object is taken into consideration and a redeployment of the virtual object is terminated when dispersion is less than a reference value, when selecting the virtual object to be moved in order to minimize power consumption of the MEC servers.

10. The system of claim 7, wherein the load balancing unit comprises:
a virtual object selection unit configured to select a target redeployment virtual object; and
a virtual object deployment unit configured to dispose the target redeployment virtual object.

11. The system of claim 10, wherein the virtual object selection unit is configured to generate and initialize a set of target redeployment VOs, index and initialize the MEC servers in the MEC environment, and sequentially search all of the MEC servers for a target redeployment VO.

12. The system of claim 7, wherein the virtual object deployment unit is configured to index a set of target redeployment virtual objects in descending power for popularity, index MEC servers having popularities smaller than an average of the set of target redeployment virtual objects in ascending power for popularity, and distribute each of the indexed target redeployment virtual objects to each of the indexed MEC servers.
